(19) United States
(12) Patent Application Publication
(10) Pub. No.: US 2009/0085414 A1
(43) Pub. Date: Apr. 2, 2009

(54) AC generator for vehicles

(75) Inventor: Motoki Itoh, Oobu-shi (JP)

Correspondence Address: OLIFF & BERRIDGE, PLC, P.O. BOX 320850, ALEXANDRIA, VA, 22320-4850, US

(73) Assignee: DENSO CORPORATION, Kariya-city (JP)

(21) Appl. No.: 12/232,877

(22) Filed: Sep. 25, 2008

(30) Foreign Application Priority Data
Sep. 28, 2007 (JP) 2007-253089

(51) Int. Cl. H02K 15/14

(52) U.S. Cl. 310/42

(57) ABSTRACT

The alternator (AC generator) of this invention is provided with a front (a second) housing, a rear (a first) housing, and a bolt. A bolt hole is formed in the front housing. A nut part that the bolt is screwed into is formed in the bolt hole. Another bolt hole that the bolt is inserted into is formed in the rear housing. The bolt has a large diameter portion that is inserted into the bolt hole of the rear housing The entire circumference of the outer surface of the large diameter portion contacts the inner side of the bolt hole. Therefore, when the bolt is tightened, positioning of the direction of a circumference of the first housing to the second housing can be performed by inserting the bolt so that the outer surface of the large diameter portion contacts the inner side of the bolt hole. Thus, positioning of the housings can be carried out without enlarging its size, and without using a jig, etc.

### CROSS-REFERENCE TO RELATED APPLICATION

This application is based on and claims the benefit of priority from earlier Japanese Patent Application No. 2007-253089 filed Sep. 28, 2007, the description of which is incorporated herein by reference.

### BACKGROUND OF THE INVENTION

1. Technical field of the Invention

The present invention relates to an AC generator for vehicles provided with a first housing and a second housing arranged on opposite ends of a stator.

2. Description of the Related Art

Conventionally, there is an AC generator, generally known as an alternator, for vehicles provided with a first housing and a second housing arranged on opposite ends of a stator, respectively, as disclosed in Japanese Patent Application Laid-Open Publication No. 11-262213, for example.

The alternator is provided with a front housing and a rear housing. Attaching stays that extend in the direction that intersects the rotation shaft are formed on the front housing and the rear housing. Bolt insertion holes are provided in tip parts of the attaching stays.

Convex parts for positioning are formed on the front housing and the rear housing, along with the rotation shaft. These two convex parts for positioning are provided in a position that overlaps partially in the direction of a circumference.

When assembling the alternator, positioning the direction of circumferences of the front housing and the rear housing can be easily carried out by contacting the joint surfaces, which are facing each other, of the two convex parts for positioning.

However, the convex parts for positioning are projected in the direction of the diameter from the perimeter sides of the front housing and the rear housing. From that reason, the size of the alternator becomes large and the interference between the components of the vehicles must fully be taken into consideration at the time of loading the alternator into the vehicles. Further, the alternator must be attached to the vehicles in the state where the two convex parts for positioning were contacted each other, and therefore a binding member for restraining these convex parts is needed separately.

### SUMMARY OF THE INVENTION

The present invention has been made in light of the circumstances provided above, and has as its object to provide an AC generator for vehicles that can assist in positioning the circumference of a housing easily, without enlarging its size, and without using a jig.

In order to resolve the problems, the inventor of the present invention has conducted research through much practical experimentation. As a result, the inventor has made an invention by carrying out the positioning of the first housing in the direction of a circumference with the bolt that fixes the first housing to the second housing.

Specifically, in the AC generator for vehicles according to a first aspect, an AC generator for vehicles comprises a stator; a rotor; a first housing that supports one end of the rotor rotatably arranged in one end of the stator; a second housing that supports another end of the rotor rotatably arranged in another end of the stator; and a bolt having an axial part that has a screw part formed at one end and a head part formed at another end.

The first housing further comprises a bolt hole that penetrates in a direction of the axis of the rotor and into which the bolt is inserted therein.

The second housing further comprises another bolt hole that penetrates in the direction of the axis of the rotor and a nut part to which the bolt is screwed into.

The first housing is fixed to the second housing by inserting the bolt into the bolt hole of the first housing and contacting the head part to the first housing, and screwing the screw part of the bolt into the nut part formed in the bolt hole of the second housing.

The bolt further comprises a large diameter portion with a larger outer diameter than the other parts of the axial part formed in the other end of the axial part.

The outer diameter of the large diameter part is set so that when the large diameter part is inserted into the bolt hole of the first housing, the entire circumference of an outer surface of the large diameter part contacts the inner surface of the bolt hole of the first housing.

According to the above composition, the first housing can be fixed to the second housing by inserting the bolt into the bolt hole provided in the first housing.

The large diameter portion is disposed on the bolt. When the large diameter part is inserted into the bolt hole of the first housing, the entire circumference of the outer surface of the large diameter part contacts the inner surface of the bolt hole.

Therefore, when the bolt is tightened, positioning of the circumference of the first housing to the second housing can be performed by inserting the bolt so that the outer surface of the large diameter portion contacts the inner side of the bolt hole.

Moreover, positioning of the housings can be carried out, in contrast to the prior art, without enlarging its size, and without using a jig, etc.

In the AC generator for vehicles according to a second aspect, the large diameter portion is provided at a position distant from the head part such that the large diameter portion is separated from the bolt hole of the first housing in the direction of an axis of the axial part when the bolt is fully tightened In the AC generator for vehicles according to a third aspect, the first housing and the second housing are provided with a stay having a through hole or a slot formed in a tip part of the stay for attaching the AC generator, the stay extending in the direction crossing the direction of the axis of the rotor.

It should be appreciated that the first housing and the second housing as used in this specification are introduced for convenience, in order to distinguish the housings.

### BRIEF DESCRIPTION OF THE DRAWINGS

In the accompanying drawings:

FIG. 1 is an elevational view of an alternator, according to an embodiment of the present invention;

FIG. 2 is a fragmentary sectional view showing a seen from the side of the alternator;

FIG. 3 is a sectional view of a bolt circumference showing the state in the middle of tightening the bolt; and

FIG. 4 is a sectional view of the bolt circumference in the state where the bolt is fully tightened.

### DETAILED DESCRIPTION OF THE PREFERRED EMBODIMENTS

With reference to the accompanying drawings, an embodiment of the present invention will now be described in detail.

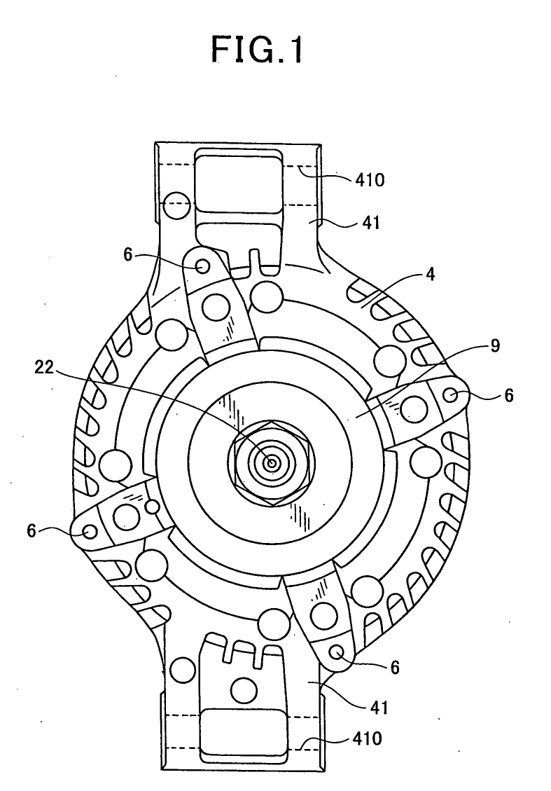

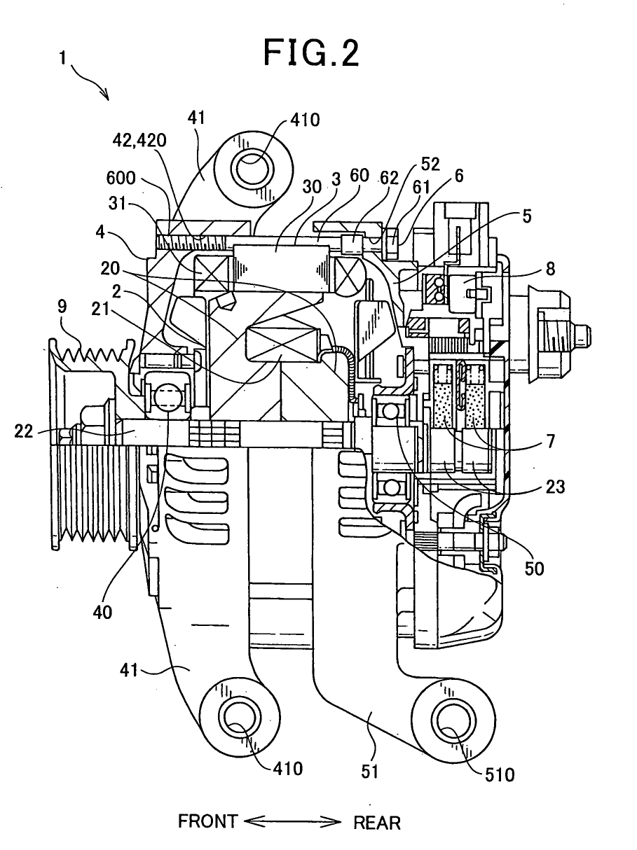

First, the structure of an alternator is explained with reference to FIGS. 1 and 2. Here, FIG. 1 is an elevational view of the alternator in the present embodiment, and FIG. 2 is a fragmentary sectional view seen from the side of the alternator. It should be appreciated that the directional arrows used in FIG. 2 are introduced for convenience, in order to distinguish direction.

As shown in FIGS. 1 and 2, an AC generator 1 for vehicle (hereinafter referred to an “alternator”) comprises a rotor 2, a stator 3, a second housing 4 (hereinafter referred to a “front housing”), a first housing 5 (hereinafter referred to a “rear housing”), and a bolt 6.

The rotor 2 is a member that generates magnetic flux when current flows, and rotates when a driving force of an engine (not shown) is transmitted. The rotor 2 comprises a rotor core 20, a field coil 21, and a rotation shaft 22. The field coil 21 that constitutes a magnetic circuit is wound around the rotor core 20. The rotor core 20 that the field coil 21 was wound on is fixed to the rotation shaft 22.

The field coil 21 is connected to a collector ring 23 provided in the rear end of the rotation shaft 22. The field coil 21 is connected to a control circuit 8 arranged behind the rear housing 5 via the brush 7 in contact with the collector ring 23. The pulley 9 which transmits the engine driving force is fixed to the front end of the rotation shaft 22.

The stator 3 is a member that generates an alternating current by interacting with magnetic flux that the rotor 2 generates. The stator 3 comprises a stator core 30 and a stator coil 31. The stator coil 31 is wound around the stator core 30 that constitutes the magnetic circuit.

The stator core 30 that the stator coil 31 was wound on is arranged coaxially and separately at a predetermined distance from the perimeter side of the rotor core 20 in the direction of a diameter. The stator coil 31 is connected to the control circuit 8.

The front housing 4 is a substantially bottomed cylindrical member made of aluminum, for example, which is arranged in a front side of the stator 3, and supports the front part of the rotor 2 rotatably.

The front housing 4 fits into the front end of the stator core 30, and it is arranged so that the front of the stator core 30 may be covered. The front side of the rotation shaft 22 is supported rotatably via a bearing 40.

A plural of stays 41 (leg parts) are formed on the front housing 4. The stays 41 extend in the direction crossing the direction of an axis of the rotor 2. Through holes 410 for attaching the alternator 1 to an engine bracket (not shown) are formed in tip parts of the stays 41.

A bolt hole 42 penetrated in the direction of the axis of the rotor 2 is formed in the front housing 4. A nut part 420 to which the bolt 6 is screwed into is formed in the bolt hole 42.

The rear housing 5 is a substantially bottomed cylindrical member made of aluminum, for example, which is arranged in a rear side of the stator 3, and supports the rear part of the rotor 2 rotatably.

The rear housing 5 fits into the rear end of the stator core 30, and it is arranged so that the back of the stator core 30 may be covered. The rear side of the rotation shaft 22 is supported rotatably via a bearing 50.

A stay 51 (leg part) is formed on the rear housing 5. The stay 51 extends in the direction crossing the direction of the axis of the rotor 2. A through hole 510 for attaching the alternator 1 on the engine bracket is formed in a tip part of the stay 51.

A bolt hole 52 having a circle shape section is formed in the rear housing 5, which penetrates in the direction of the axis of the rotor 2, and the bolt 6 may be inserted therein. As for the bolt hole 52, the formation position is adjusted so that the stay 51 may be stationed to the stays 41 in the predetermined position of the direction of a circumference.

The bolt 6 is a member inserted in the bolt hole 52 of the rear housing 5, and fixes the rear housing 5 to the front housing 4. The bolt 6 comprises an axial part 60 that has the screw part 600 in one end, and a head part 61 formed in another end of the axial part 60.

A cylindrical large diameter portion 62 with a larger outer diameter than the other parts of the axial part 60 is formed in the other end of the axial part 60. An outer diameter of the large diameter part 62 is set so that when the large diameter part 62 is inserted into the bolt hole 52 of the rear housing 5, the entire circumference of an outer surface of the large diameter part 62 contacts an inner surface of the bolt hole 52 of the rear housing 5.

When the bolt 6 is fully tightened, the large diameter portion 62 is provided at a position distant from the head part 61 which will be in the state where the large diameter portion 62 is separated from the bolt hole 52 in the direction of an axis of the axial part 60.

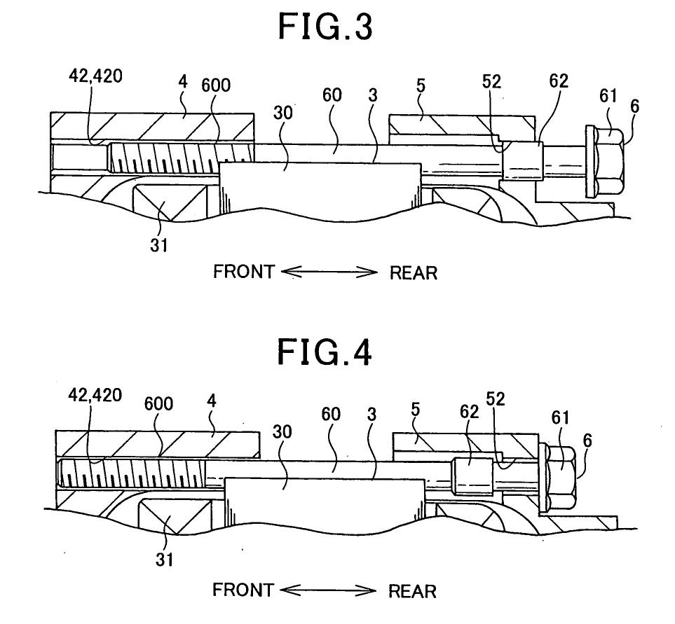

Here, with reference to FIGS. 3 and 4, the assembly of the front housing 4 and the rear housing 5 is explained. FIG. 3 is a sectional view of the bolt circumference in the middle of tightening the bolt, and FIG. 4 is a sectional view of the bolt circumference in the state where the bolt is fully tightened. It should be appreciated that the directional arrows used in FIGS. 3 and 4 are introduced for convenience, in order to distinguish direction.

As shown in FIG. 3, the front housing 4 fits into the front end of the stator core 30, and it is arranged so that the front part of the stator core 30 may be covered. The rear housing 5 is arranged so that the back of stator core 30 may be covered. A bolt 6 is inserted in the bolt hole 52 of the rear housing 5. The screw part 600 of the bolt 6 screws into the nut part 420 formed in the bolt hole 42 of the front housing 4.

When the bolt 6 is tightened further, the large diameter portion 62 will be inserted in the bolt hole 52 of the rear housing 5. The outer diameter of the large diameter part 62 is set so that when the large diameter part 62 is inserted into the bolt hole 52, the entire circumference of the outer surface of the large diameter part 62 contacts the inner surface of the bolt hole 52 of the rear housing 5.

Therefore, when tightening the bolt 6, positioning of the circumference of the rear housing 5 to the front housing 4 can be performed by inserting the large diameter part 62 with entire circumference of the outer surface of the large diameter part 62 contacting the inner surface of the bolt hole 52 of the rear housing 5.

Then, when the bolt 6 is tightened further, the head part 61 of the bolt 6 contacts the rear housing 5, and presses the rear housing 5 to the front. Thereby, the rear housing 5 fits into the rear end of the stator core 30. Thus the rear housing 5 is fixed to the front housing 4.

By the way, the large diameter portion 62 is formed at a position distant from the head part 61. Therefore, as shown in FIG. 4, when the bolt 6 is fully tightened, the large diameter portion 62 will be in the state where it is separated from the bolt hole 52. Thereby, the increase in the tightening torque accompanying the interference with the large diameter portion 62 and the bolt hole 52 can be suppressed. As a result, the tightening torque of the bolt 6 at the time of tightening the bolt 6 is moderated.

Next, the operation of the alternator 1 is explained with reference to FIG. 2. The current is supplied to the field coil 21 from the control circuit 8 via the brush 7 and the collector ring 23. The engine driving force is transmitted to the rotor 2 via the pulley 9. The rotor 2 generates the magnetic flux and rotates.

The alternating current is generated by the stator 3 interlinkaging with magnetic flux that the rotor 2 generates. The alternating current that the stator 3 has generated is changed into direct current in the control circuit 8, and the current is supplied to each part of the vehicle.

Finally, the effect of the embodiment is explained. According to the present embodiment, the rear housing 5 can be fixed to the front housing 4 by inserting the bolt 6 into the bolt hole 52 provided in the rear housing 5.

There is provided the large diameter part 62 on the bolt 6 such that the outer diameter of the large diameter part 62 is set so that when the large diameter part 62 is inserted into the bolt hole 52, entire circumference of the outer surface of the large diameter part 62 contacts the inner surface of the bolt hole 52.

Therefore, when tightening the bolt 6, positioning of the circumference of the rear housing 5 to the front housing 4 can be performed by inserting the large diameter part 62 with the entire circumference of the outer surface of the large diameter part 62 contacting the inner surface of the bolt hole 52 of the rear housing 5. Moreover, positioning of the housings 4 and 5 can be carried out, in contrast to the prior art, without enlarging its size, and without using a jig, etc.

Further, when the bolt 6 is fully tightened, the large diameter portion 62 can be separated from the bolt hole 52, according to the present embodiment. If the bolt 6 is tightened when the large diameter part 62 is in the state of being in the bolt hole 52, tightening torque will increase by these interferences.

Therefore, when a bolt 6 is fully tightened, the increase in the tightening torque at that time can be suppressed by making the large diameter portion 62 separated from the bolt hole 52. Thus, the tightening torque of the bolt 6 at the time of fully tightening the bolt 6 is correctly manageable. Thereby, the quality of the alternator 1 is secured.

Furthermore, according to the present embodiment, the alternator 1 can be attached to the engine bracket using the through holes 410 and 510 formed in the stays 41 and 51 of the rear housing 5 and the front housing 4.

Positioning of the front housing 4 and the rear housing 5 in the direction of the circumference can be performed by the large diameter portion 62 of the bolt 6. Therefore, if the alternator 1 is attached using the through holes 410 and 510 formed in stays 41 and 51, there will be no excessive stress to the stays 41 and 51 and the housings 4 and 5. Thus, breakage of the stays 41 and 51 and the housings 4 and 5 can be prevented.

It should be appreciated that although the bolt hole 52 that the large diameter portion 62 of the bolt 6 is inserted is formed in the rear housing 5, and the nut part 420 to which the screw part 600 of the bolt 6 is screwed into is formed in the front housing 4 in the present embodiment as an example, it is not intended to be limited to the embodiments described above. A bolt hole may be provided in the front housing 4, and a nut part may be provided in the rear housing 5.

Further, although the through holes 410 and 510 for attaching are formed in the tip parts of the stays 41 and 51 in the present embodiment as an example, it is not intended to be limited to the embodiments described above. Slots for attaching may be formed instead, for example.

What is claimed is:

1. AC generator for vehicles comprising:
a stator;
a rotor;
a first housing that supports one end of the rotor rotatably arranged in one end of the stator;
a second housing that supports another end of the rotor rotatably arranged in another end of the stator; and
a bolt having an axial part that has a screw part formed in one end and a head part formed in another end;
wherein, the first housing further comprises a bolt hole that penetrates in a direction of the axis of the rotor and the bolt is inserted therein,
the second housing further comprises another bolt hole that penetrates in the direction of the axis of the rotor and a nut part to which the bolt is screwed into,
the first housing is fixed to the second housing by inserting the bolt into the bolt hole of the first housing and contacting the head part to the first housing, and screwing the screw part of the bolt with the nut part formed in the bolt hole of the second housing,
the bolt further comprises a large diameter portion with a larger outer diameter than the other parts of the axial part formed in the other end of the axial part, and
an outer diameter of the large diameter part is set so that when the large diameter part is inserted into the bolt hole of the first housing, an entire circumference of an outer surface of the large diameter part contacts an inner surface of the bolt hole of the first housing.

2. An AC generator for vehicles according to claim 1, wherein the large diameter portion is provided in a position distant from the head part such that the large diameter portion is separated from the bolt hole of the first housing in the direction of an axis of the axial part when the bolt is fully tightened.

3. An AC generator for vehicles according to claim 1, wherein the first housing and the second housing are provided with a stay having a through hole or a slot formed in a tip part of the stay for attaching the AC generator, the stay extending in a direction crossing a direction of the axis of the rotor.

4. An AC generator for vehicles according to claim 2, wherein the first housing and the second housing are provided with a stay having a through hole or a slot formed in a tip part of the stay for attaching the AC generator, the stay extending in a direction crossing a direction of the axis of the rotor.
